(19) United States
(12) Patent Application Publication
(10) Pub. No.: US 2012/0175997 A1
(43) Pub. Date: Jul. 12, 2012

(54) SWITCHED RELUCTANCE MOTOR

(75) Inventors: Chee Woo LEE, Gyunggi-do (KR); Han Kyung BAE, Gyunggi-do (KR); Ki Young LEE, Gyunggi-do (KR)

(73) Assignee: SAMSUNG ELECTRO-MECHANICS CO., LTD., Gyunggi-do (KR)

(21) Appl. No.: 13/249,597

(22) Filed: Sep. 30, 2011

(30) Foreign Application Priority Data
Jan. 10, 2011 (KR) 1020110002436

(51) Int. Cl. H01R 39/44

(52) U.S. Cl. 310/241

(57) ABSTRACT

Disclosed herein is a switched reluctance motor including a rotor having a coil wound therearound; commutators connected to both ends of the rotor; brushes mechanically contacting the commutators by rotation of the rotor; and a stator having the brushes fixed thereto and having stator poles, wherein the brushes are moved by an advance angle from a connection axis of stator poles counterclockwise, and a dwell angle, a voltage application period is controlled by arc angles of the commutator and the brush.

### CROSS REFERENCE TO RELATED APPLICATION

This application claims the benefit of Korean Patent Application No. 10-2011-0002436, filed on Jan. 10, 2011, entitled “Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

A general switched reluctance motor has a magnetic structure in which both of a stator and a rotor are a salient pole. In addition, the stator has a concentrated winding coil wound therearound, and the rotor is formed of only an iron core without using any excitation device (e.g., a winding, a permanent magnet, or the like) to have excellent price competitiveness. Further, a speed changeable switched reluctance motor may stably generate a continuous torque with the aid of a converter using a power semiconductor and a position sensor, and may be easily controlled according to performance required for each application.

Even though the switched reluctance motor is inexpensive due to a simple rotor structure, it has problems in that it should use a converter formed of a semiconductor switch in order to generate a reluctance torque, has an increased cost of the entire system, and should include an expensive control circuit capable of performing rapid processing in order to appropriately perform a control during rapid driving thereof.

A universal motor mainly used in fields such as a cleaner, an electric tool, or the like, uses a commutator and a brush, which are a simple mechanical structure, to generate a torque without using the converter and the position sensor, and has been widely used in the above fields due to an advantage of having an inexpensive motor structure rather than improving performance by the control. However, in the universal motor, the coil is wound around the rotor as well as the stator, which causes increase in a material cost and copper loss of the rotor, thereby reducing efficiency of the motor. Therefore, it is difficult to use the universal motor in a high-end type model requiring high efficiency.

FIG. 1 is a schematic configuration diagram of a switched reluctance motor according to the prior art. The switched reluctance motor 100 of which only a single phase is shown in FIG. 1 includes a rotor 110, a stator 120 formed with a stator pole 121, and a coil 130 wound around the stator pole 121. When a current is applied to the coil, a magnetic field is generated in the stator pole, and an attractive force is generated between the stator pole 121 and the rotor 110 to rotate the rotor 110.

In addition, when a plurality of phase windings are wound around a plurality of stator poles, the phase windings of the stator poles are excited one by one to generate a torque, thereby rotating the rotor. In this case, since position feedback of the rotor is required, a position sensor is required, and a converter formed of a power semiconductor is also required in order to apply a current to the winding of the stator according to the position of the rotor. In addition, a controller having a digital signal processor (DSP), a microcontroller unit (MCU), or the like, mounted therein is required for complicated and rapid processing. As described above, since the switched reluctance motor according to the prior art should necessarily include the converter, the controller, and the position sensor for driving thereof, it may not be implemented at a low cost, has a deteriorated degree of freedom in design due to a complicated technical configuration, and has a high possibility for a fault or an error.

### SUMMARY OF THE INVENTION

The present invention has been made in an effort to provide a switched reluctance motor in which a coil is wound around a rotor instead of a stator and only a single phase winding may generate a continuous torque to reduce a production cost due to reduction in a winding, a space part is formed around a stator pole to increase air flow due to increase in a spare area, thereby improving performance of a cleaner, and a torque performing mechanical phase conversion is generated by using a commutator and a brush without using a converter and a position sensor, thereby making it possible to be implemented by a simple mechanical structure at low cost.

Further, the present invention has been made in an effort to provide a switched reluctance motor in which an advance angle and a dwell angle having a direct influence on performance of a motor is controlled by changing a position and arc angles of a commutator and a brush, thereby making it possible to perform a design according to an optimal operation point (maximal efficiency, maximal torque, or the like), and respective positive torque regions generated in two pairs of stator poles are controlled using the design method to change an overlapping torque, thereby making it possible to perform a design so as to reduce a torque ripple.

According to a first preferred embodiment of the present invention, there is provided a switched reluctance motor including: a rotor having a coil wound therearound; commutators connected to both ends of the rotor; brushes mechanically contacting the commutators by rotation of the rotor; and a stator having the brushes fixed thereto and having stator poles, wherein the brushes are moved and mounted by an advance angle from a connection axis of stator poles.

The brush may be moved and mounted by the advance angle from the connection axis of the stator poles opposite to each other counterclockwise in the case in which the rotor is rotated clockwise, and the advance angle may be a region between application of a voltage and rise of an inductance.

A dwell angle, a voltage application period, may be controlled by arc angles of the commutator and the brush.

The dwell angle may be defined as d=X+2Y, where X indicates an arc angle of the brush and Y indicates an arc angle of the commutator.

The dwell angle may be set so that a voltage is turned off before a negative torque is generated.

The commutators may have both ends connected to the coil wound around the rotor.

The brushes may be provided in two pairs, each pair of brushes being opposite to each other, and ends of one pair of brushes of the two pairs of brushes are connected to a power supply and ends of the other pair of brushes thereof are connected to a diode.

The stator pole may be formed of a permanent magnet.

The stator and the rotor may be a salient pole type.

### BRIEF DESCRIPTION OF THE DRAWINGS

FIG. 1 is a schematic configuration diagram of a switched reluctance motor according to the prior art;

FIG. 2 is a schematic configuration diagram of a switched reluctance motor according to a preferred embodiment of the present invention;

FIG. 3 is a graph showing an inductance according to a position of a rotor in a switched reluctance motor according to a preferred embodiment of the present invention;

FIG. 4 is a graph showing an applied voltage according to a position of a rotor in a switched reluctance motor according to a preferred embodiment of the present invention;

FIG. 5 is a usage state diagram showing setting of an advance angle and a dwell angle according to positions of a commutator and a brush in a switched reluctance motor according to a preferred embodiment of the present invention;

FIG. 6 is a schematic usage state diagram according to coil excitation in a switched reluctance motor according to a preferred embodiment of the present invention;

FIG. 7 is a schematic usage state diagram according to coil excitation in a switched reluctance motor according to a preferred embodiment of the present invention;

FIG. 8 is a schematic usage state diagram of phase conversion in a switched reluctance motor according to a preferred embodiment of the present invention;

FIG. 9 is a schematic usage state diagram according to coil excitation in a switched reluctance motor according to a preferred embodiment of the present invention;

FIG. 10 is a schematic usage state diagram according to coil excitation in a switched reluctance motor according to a preferred embodiment of the present invention; and

FIG. 11 is a schematic usage state diagram of phase conversion in a switched reluctance motor according to a preferred embodiment of the present invention

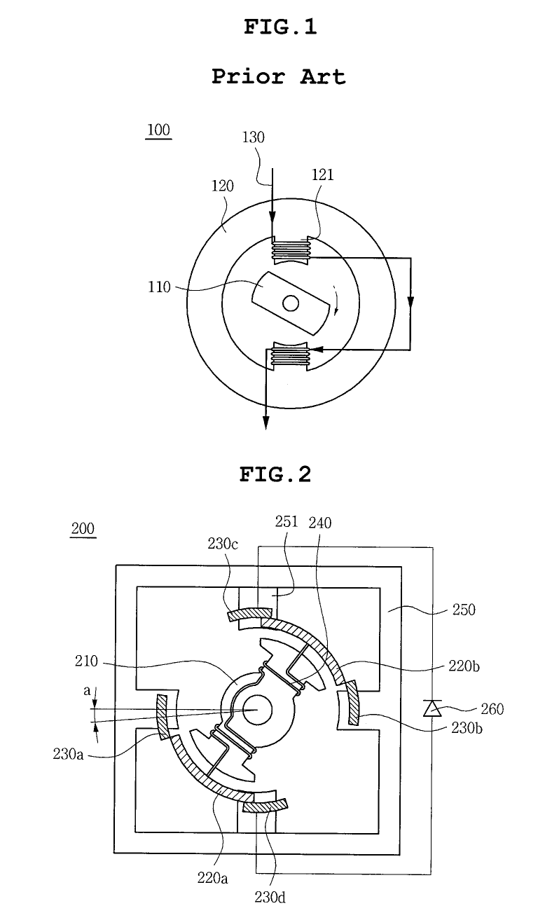

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, a switched reluctance motor according to preferred embodiments of the present invention will be described in detail with reference to the accompanying drawings.

FIG. 2 is a schematic configuration diagram of a switched reluctance motor according to a preferred embodiment of the present invention. As shown in FIG. 2, the switched reluctance motor 200 is configured to include a rotor 210, commutators 220a and 220b, brushes 230a, 230b, 230c, and 230d, a coil 240, and a stator 250.

More specifically, the rotor 210 has the coil wound therearound, and the commutators 220a and 220b are connected to both ends of the rotor and are connected to the coil 240 wound around the rotor 210. In this configuration, the rotor is connected to the two commutators 220a and 220b so that a central axis thereof coincides with those of the two commutators 220a and 220b. In addition, the stator 250 and the rotor 210 are a salient pole type.

Further, the brushes 230a, 230b, 230c, and 230d are provided in two pairs and are fixed to the stator 250, wherein each pair of brushes is opposite to each other, and the stator 250 includes two pairs of stator poles 251, wherein each pair of stator poles is opposite to each other. The brushes mechanically contact the commutators 220 by rotation of the rotor 210. In addition, when the rotor is rotated clockwise, the brushes are moved and mounted by an advance angle a from a connection axis of the stator poles 251 opposite to each other counterclockwise.

In addition, one pair of brushes 230a and 230b is connected to a power supply (not shown), and the other pair of brushes 230c and 230d is connected to a diode 260.

The stator poles 251 according to a preferred embodiment of the present invention may be formed of a permanent magnet in order to enhance a torque.

Through the above-mentioned configuration, the commutators 220a and 220b having the same axis as that of the rotor 210 are rotated together with the rotation of the rotor 210 and mechanically contact the brushes, such that a voltage is turned on/off.

Hereinafter, a structure and an operating principle of the switched reluctance motor according to a preferred embodiment of the present invention configured as described above will be described in detail.

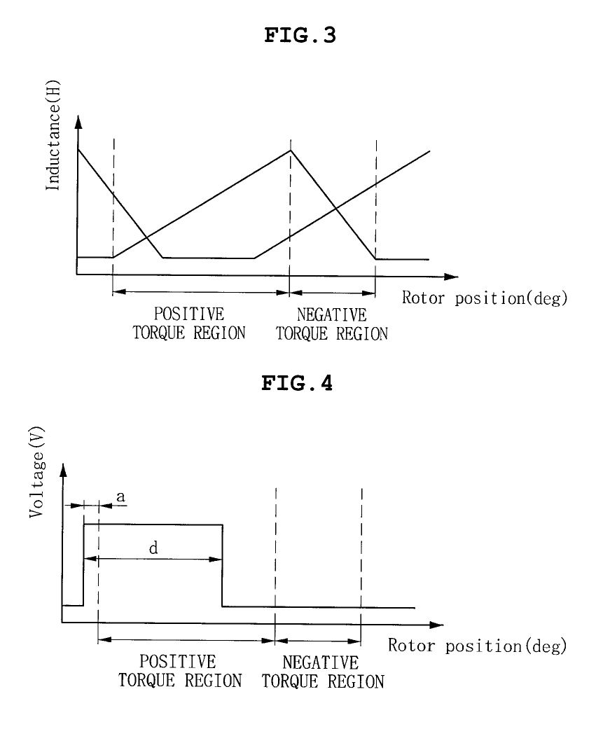

FIG. 3 is a graph showing an inductance according to a position of a rotor in a switched reluctance motor according to a preferred embodiment of the present invention;

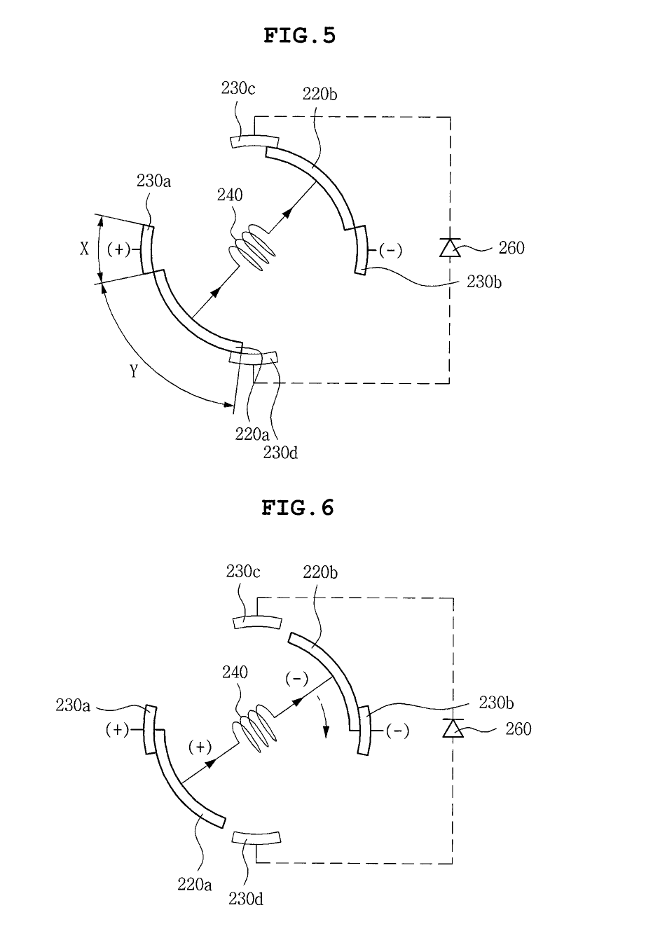

FIG. 4 is a graph showing an applied voltage according to a position of a rotor in a switched reluctance motor according to a preferred embodiment of the present invention; and FIG. 5 is a usage state diagram showing the setting of an advance angle and a dwell angle according to positions of a commutator and a brush in a switched reluctance motor according to a preferred embodiment of the present invention.

As shown in FIGS. 3 to 5, a desired current value is not immediately reached during application of a voltage, and a current is not immediately removed during turnoff of the voltage, due to characteristics of an inductance. Therefore, it is important to design the advance angle a for building-up current and a dwell angle for turning off the voltage before a negative torque is generated in a minimal inductance period. It is possible to implement roles of the position sensor and the converter according to the prior art through this.

More specifically,

$$T ( θ , i ) = \frac{1}{2} {i}^{2} \frac{d L ( θ )}{d θ} ,$$

Where T indicates a torque, θ indicates a position of a rotor, i indicates a phase current, and L indicates an inductance.

As may be appreciated from the above equation, a torque is determined by a generated current and a change rate of an inductance.

Therefore, the advance angle indicates a region between the application of the voltage and rise of the inductance, the voltage is applied by the advance angle a, and the inductance then rises, such that a positive torque region is formed. A voltage application period, which is the dwell angle d, is controlled by an arc angle X of the brush and an arc angle Y of the commutator. As a result, the dwell angle is defined as d=X+2Y, where X indicates the arc angle of the brush and Y indicates the arc angle of the commutator. In addition, the dwell angle d is set so that the voltage is turned off before a negative torque is generated.

Hereinafter, torque generation and phase conversion of the switched reluctance motor according to a preferred embodiment of the present invention will be described in detail.

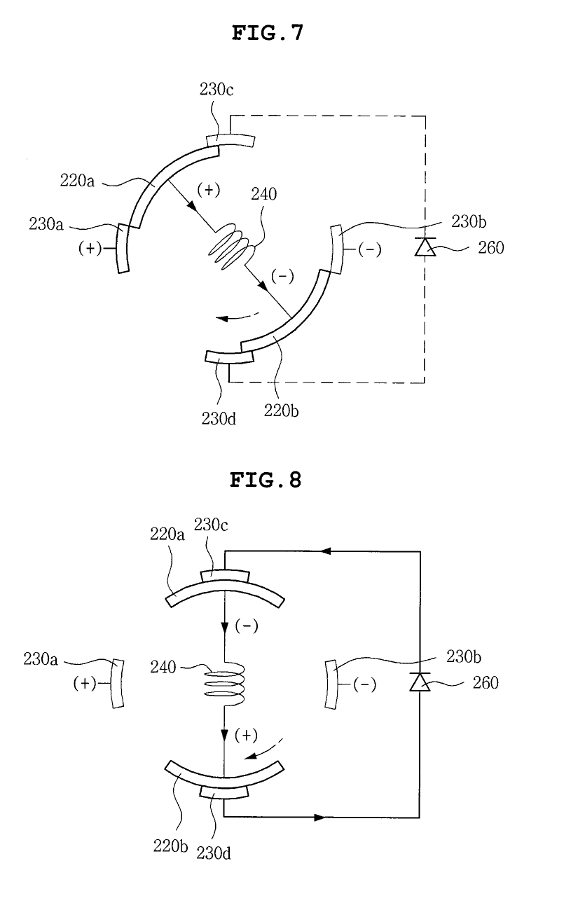

FIGS. 6 and 7 are schematic usage state diagrams according to coil excitation in a switched reluctance motor according to a preferred embodiment of the present invention; and FIG. 8 is a schematic usage state diagram of phase conversion in a switched reluctance motor according to a preferred embodiment of the present invention. As shown in FIGS. 6 to 8, when a (+) voltage is applied to the brush 230a and a (−) voltage is applied to the brush 230b, such that a current flows in the coil 240, the commutators 220a and 220b are rotated clockwise in a state in which they contact the brushes 230a and 230b.

In addition, as shown in FIG. 7, the commutators 220 and 220b contact all of the upper/lower and left/right brushes 230a, 230b, 230c, and 230d. At this time, a reverse voltage is applied to the diode 260, such that the diode is not conducted. Further, as shown in FIG. 8, when the commutators 220a and 220b contact only the upper/lower brushes 230c and 230d, an external voltage is not applied by the left/right brushes 230a and 230b and the voltage is reversed due to inductance characteristics of the coil. In addition, a current having the same direction flows in the coil, and a constant voltage is applied to the diode.

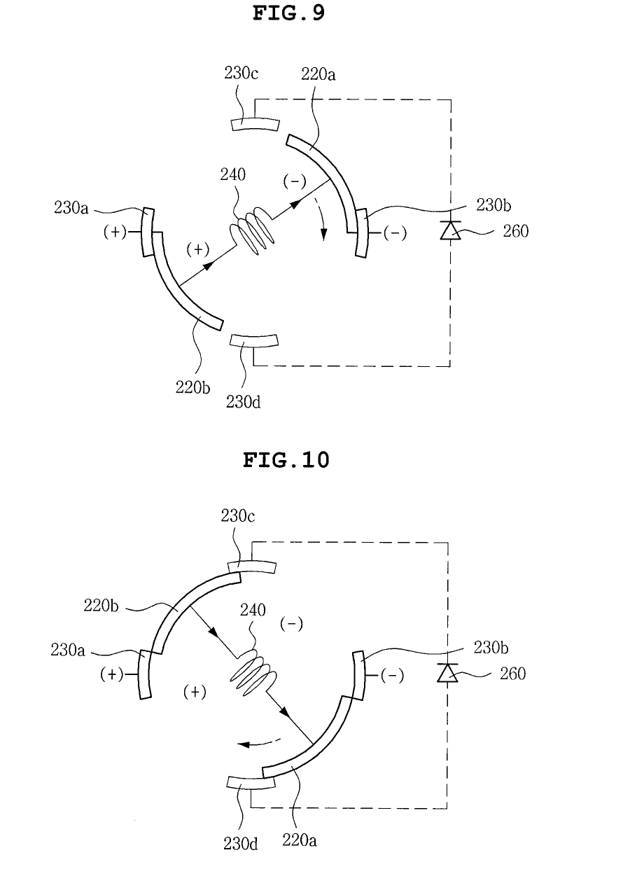

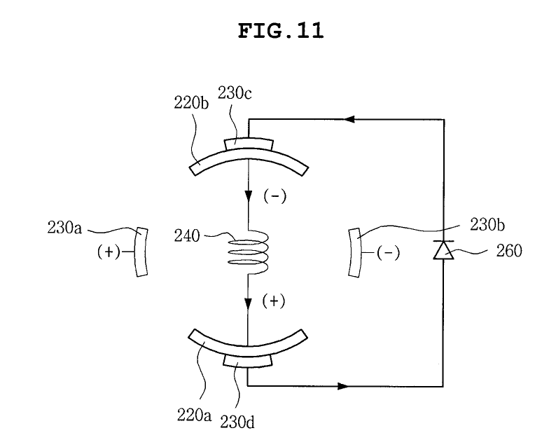

FIGS. 9 and 10 are schematic usage state diagrams according to coil excitation in a switched reluctance motor according to a preferred embodiment of the present invention; and FIG. 11 is a schematic usage state diagram of phase conversion in a switched reluctance motor according to a preferred embodiment of the present invention. As shown in FIGS. 9 to 11, when the (+) voltage is applied to the brush 230b and the (−) voltage is applied to the brush 230a, such that the current flows in the coil 240, the commutators 220a and 220b are rotated clockwise in a state in which they contact the brushes 230a and 230b. In addition, as shown in FIG. 10, the commutators 220 and 220b contact all of the upper/lower and left/right brushes 230a, 230b, 230c, and 230d. At this time, the reverse voltage is applied to the diode 260, such that the diode is not conducted.

Further, as shown in FIG. 11, when the commutators 220a and 220b contact only the upper/lower brushes 230c and 230d, the external voltage is not applied by the left/right brushes 230a and 230b and the voltage is reversed due to the inductance characteristics of the coil. In addition, the current having the same direction flows in the coil, and a constant voltage is applied to the diode.

With the switched reluctance motor according to the preferred embodiment of the present invention, the coil is wound around the rotor instead of the stator and only a single phase winding may generate continuous torque to reduce a production cost due to reduction in the winding, a space part is formed around the stator pole to increase air flow due to increase in a spare area, thereby improving performance of a cleaner, and a torque performing mechanical phase conversion is generated by using a commutator and a brush without using a converter and a position sensor, thereby making it possible to be implemented by a simple mechanical structure at low cost. In addition, the advance angle and the dwell angle having a direct influence on performance of the motor is controlled by changing the position and the arc angles of a commutator and a brush, thereby making it possible to perform a design according to an optimal operation point (maximal efficiency, maximal torque, or the like), and respective positive torque regions generated in two pairs of stator poles are controlled using the design method to change an overlapping torque, thereby making it possible to perform a design so as to reduce a torque ripple. Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A switched reluctance motor comprising:
a rotor having a coil wound therearound;
commutators connected to both ends of the rotor;
brushes mechanically contacting the commutators by rotation of the rotor; and
a stator having the brushes fixed thereto and having stator poles,
wherein the brushes are moved and mounted by an advance angle from a connection axis of stator poles opposite to each other.

2. The switched reluctance motor as set forth in claim 1, wherein the brush are moved and mounted by the advance angle from the connection axis of the stator poles opposite to each other counterclockwise in the case in which the rotor is rotated clockwise, and the advance angle is a region between application of a voltage and rise of an inductance.

3. The switched reluctance motor as set forth in claim 1, wherein a dwell angle, a voltage application period is controlled by arc angles of the commutator and the brush.

4. The switched reluctance motor as set forth in claim 3, wherein the dwell angle is defined as d=X+2Y, where X indicates an arc angle of the brush and Y indicates an arc angle of the commutator.

5. The switched reluctance motor as set forth in claim 1, wherein the dwell angle is set so that a voltage is turned off before a negative torque is generated.

6. The switched reluctance motor as set forth in claim 1, wherein the commutators are connected to the coil wound around the rotor.

7. The switched reluctance motor as set forth in claim 1, wherein the brushes are provided in two pairs, each pair of brushes being opposite to each other, and one pair of brushes of the two pair of brushes is connected to a power supply and the other pair of brushes thereof is connected to a diode.

8. The switched reluctance motor as set forth in claim 1, wherein the stator pole is formed of a permanent magnet.

9. The switched reluctance motor as set forth in claim 1, wherein the stator and the rotor are a salient pole type.
